(19) United States
(12) Patent Application Publication
(10) Pub. No.: US 2023/0287180 A1
(43) Pub. Date: Sep. 14, 2023

(54) WIRE ENAMEL COMPOSITION COMPRISING POLYAMIDEIMIDE

(71) Applicant: ELANTAS EUROPE S.R.L., Collecchio (IT)

(72) Inventors: Andrea Ceci, Ascoli Piceno (IT); Giovanni Loggi, San Benedetto del Tronto (IT); Giovanna Biondi, San Benedetto del Tronto (IT)

(21) Appl. No.: 18/026,152

(22) PCT Filed: Sep. 20, 2021
(86) PCT No.: PCT/EP2021/075752

§ 371 Date: Mar. 14, 2023

(30) Foreign Application Priority Data
Sep. 22, 2020 (EP) 20197470.6

(51) Int. Cl. C08G 73/14; C08G 73/10; C08K 5/3415

(52) U.S. Cl. CPC C08G 73/14; C08G 73/1032; C08K 5/3415; C08K 2003/2227

(57) ABSTRACT

The present invention relates to a polyamideimide composition that is highly suitable for use as primary insulation for wires. The composition comprises from 55 to 65 pbw of N-n-butyl pyrollidone, from 25 to 40 pbw of polyamideimide resin, from 0 to 20 pbw of other components, wherein the polyamideimide resin has a Mw of between 10000 to 40000 g/mol (Dalton) and a Mw/Mn ratio between 1,1 and 2.

The present invention relates to a wire enamel composition comprising polyamideimide.

In transformers, generators, and electric motors the electrical insulating material protecting the copper or aluminum wire is a thin coating of high performance polymer. The coating, referred to as primary electrical insulation or wire enamel, is as thin as possible in order to obtain the maximum number of turns in each slot space. Adequate thermal, mechanical and electrical properties must be maintained. One such polymer, used as primary electrical insulation, is poly(amide-imide) or polyamideimide resin. Outstanding characteristics include high thermal performance, chemical and abrasion resistance, and low coefficient of friction. Polyamideimide coating compositions form flexible and durable films, and are particularly useful as wire enamels, varnishes, adhesives for laminates, non-stick coatings, polyamideimidents and the like. These compositions are particularly noted for their long term high temperature capability (=220° C. (430 F)).

In GB570858 the preparation of aromatic polyamideimide resins is disclosed by reacting trimellitic anhydride and aromatic diamines. Normally these reactions are carried out in an aprotic solvent such as N-methylpyrrolidone (NMP), dimethylacetamide (DMAc) or dimethylformamide (DMF).
In U.S. Pat. No. 3,541,038 the preparation of aromatic polyamideimide resins is described using trimellitic anhydride and a polyisocyanate, preferably a diisocyanate. This reaction is preferably carried out using N-methylpyrrolidone (NMP) as a solvent. Alternatively, a mixture of NMP with an aromatic hydrocarbon can be used as solvent.

It was found some time ago that there might be potential health effects for people who are exposed to NMP. Alternative solvents such as tetrahydrofuran (THF), methylethyl ketone (MEK), gamma butyrl lactone (GBL), or dimethylsulfoxide (DMSO) are known, but they have drawbacks such as boiling points which are too low for use as reaction solvent, low polymer resin solubility, or poor storage stability, which may change the performance of the polymer in the application for which it is to be used.

Although NMP is safe to use when handled in a proper way and when sufficient safety and health precautions are taken, various documents have been published relating to alternative solvents, such as those disclosed in US2013/0217812, WO2013/090933, WO2013/107822, US2015/0299393, and WO2015/144663. In US2015/0299393 the preparation of polyamideimide resin in alternative lower toxicity solvents such as N-formyl morpholine (NFM) and N-acetyl morpholine (NAM) is disclosed. These lower toxicity solvents (main solvents) can be used in combination with a co-solvent (or second solvent), where the amount of the co-solvent is lower than the amount of the main solvent. A large number of potential co-solvents is mentioned in this document. It is said that the polyamideimide resin that is prepared in this way can be used as a coating composition for wire coating, however no commercial wire-coating systems are known based on these compositions.

In WO2013/107822 various solvents are disclosed that can be used as an alternative solvent to replace NMP in wire enamel compositions comprising polyamideimide resin. In WO2013/107822 an example is given of a wire enamel composition that is suitable for use to enamel a copper wire. The inventors for the present application repeated the experiments in WO2013/107822 and found that although some of the properties of the enamelled copper wire using the alternative solvent are comparative to the results obtained by using the NMP-solvent, all-in-all the properties of the enamelled copper wire using the alternative solvent were insufficient to use the composition as a replacement for a composition based on NMP. In particular the cut through resistance, ethanol resistance, flexibility, and Tanδ did not meet the commercial specifications for NMP-based polyamideimide resin compositions for wire enamel application.

The present invention relates to a composition that meets all requirements to qualify as a true replacement for wire enamel compositions comprising NMP as a solvent.

The composition according to the present invention comprises:
a. from 55 to 65 pbw of N-n-butyl pyrollidone (NBP)
b. from 25 to 40 pbw of a polyamideimide resin
c. from 0 to 20 pbw of other components
   wherein the polyamideimide resin has a Mw of between 10000 to 40000 g/mol (Dalton) and a Mw/Mn ratio between 1,1 and 2.

The present invention further relates to the use of this composition as an insulation material for copper or aluminium conductive materials.

The present invention further relates to the preparation of a polyamideimide resin wherein an anhydride is reacted with a di-isocyanate, using N-n-butyl pyrollidone as a solvent, in the presence of a moderator compound at a temperature in the range of 80 to 120° C.

The present invention further relates to a process for enamelling a metal wire with the composition according to the present invention.

The polyamideimides resin used in the current invention can be from polycarboxylic acids or their anhydrides in which two carboxyl groups are in a vicinal position and in which there must be at least one further functional group, and from polyamines having at least one primary amino group which is capable of forming an imide ring, or from compounds having at least 2 isocyanate groups. The polyamideimides can also be obtained by reacting polyamides, polyisocyanates which contain at least 2 NCO groups, and cyclic dicarboxylic anhydrides which contain at least one further group which can be subjected to reaction by condensation or addition.

Furthermore, it is also possible to prepare the polyamideimides from diisocyanates or diamines and dicarboxylic acids, provided one of the components already contains the imide group. For instance, it is possible in particular first to react a tricarboxylic anhydride with a diprimary diamine to give the corresponding diimidocarboxylic acid, which is then reacted with a diisocyanate to form the polyamideimide.
For the preparation of the polyamideimides, preference is given to the use of tricarboxylic acids or anhydrides thereof in which 2 carboxyl groups are in a vicinal position. Preference is given to the corresponding aromatic tricarboxylic anhydrides, for example trimellitic anhydride, naphthalene tricarboxylic anhydrides, bisphenyl tricarboxylic anhydrides, and other tricarboxylic acids having 2 benzene rings in the molecule and 2 vicinal carboxyl groups, such as the examples given in DE-A 19 56 512. Very particular preference is given to the employment of trimellitic anhydride. As amine component it is possible to employ the diprimary diamines already described in connection with the polyamidocarboxylic acids. The possibility also exists, furthermore, of employing aromatic diamines containing a thiadiazole ring, for example 2,5-bis(4-aminophenyl)-1,3,4-thiadiazole, 2,5-bis(3-aminophenyl)-3,3,4-thiadiazole, 2-(4-aminopbenyl)-5-(3-aminophenyl)-1,3,4-thiadiazole, and also mixtures of the various isomers.
Diisocyanates suitable for the preparation of the polyamideimides are aliphatic diisocyanates, such as tetramethylene, hexamethylene, heptamethylene and tri methylhexamethylene diisocyanates; cycloalipbatic diisocyanates, for example isophorone diisocyanate, ω,ω′-diisocyanato-1,4-dimethylcyclohexane, cyclohexane 1,3-diisocyanate, cyclohexane 1,4-diisocyanate, 1-methylcyclohexane 2,4-diisocyanate and dicyclohexyl- methane 4,4′-diisocyanate; aromatic diisocyanates, for example phenylene, tolylene, naphthylene and xylylene diisocyanates, and also substituted aromatic systems, for example diphenyl ether, diphenyl sulphide, diphenyl sulphone and diphenylmethane diisocyanates; mixed aromatic- aliphatic and aromatic-hydroaromatic diisocyanates, for example 4-isocyanatomethylphenyl isocyanate, tetrahydronaphthylene 1,5-diisocyanate and hexahydrobenzidine 4,4′-diisocyanate. Preference is given to the use of 4,4′-diphenylmethane diisocyanate, 2,4- and 2,6-tolylene diisocyanate and hexamethylene diisocyanate.

It was found that a polyamideimide resin solved in NBP that shows the beneficial properties necessary to qualify as a wire enamel, can only be obtained when the polyamideimide resin is prepared in NBP under well-defined reaction conditions. It was found that the reaction temperature should not be too high, preferably in the range from 80 to 130° C., more preferably in the range from 80 to 120° C. It was found that when the reaction temperature is above 130° C., the reaction is too fast and uncontrolled to obtain a polyamideimide resin with a Mw of at least 10000 g/mol and a Mw/Mn ratio between 1,1 and 2. When the reaction temperature is below 80° C. the reaction is very slow, if occurring at all, to be useful in practice for the manufacture of a polyamideimide resin.

It was further found to be beneficial to have a small amount of moderator compound, such as a low molecular weight monoanhydrides or monocarboxylic acid, present in the reaction mixture. Examples of suitable low molecular weight monocarboxylic acids include (C1-C10) monocarboxylic acids or C4-C6 branched monocarboxylic acids, such as formic acid, acetic acid, propionic acid and others, examples of suitable anhydrides include phthalic anhydride. The amount of the low molecular weight monoanhydride or monocarboxylic acid in the reaction mixture should be from 4 to 8 mol %, based on the amount of polyamideimide resin formed in the reaction.

The present invention allows for the preparation of a solution comprising N-n-butyl pyrrolidone as the main solvent and a polyamideimide resin in an amount of >21 wt. %, the polyamideimide resin having a Mw of between 10000 to 40000 g/mol (Dalton) and a Mw/Mn ratio between 1,1 and 2.

This solution may comprise other solvents, but the amount of these other solvents is much lower than the amount of N-n-butyl pyrrolidone.

The present invention also relates to the manufacturing of enamelled wires by using the composition of the current invention.

The coating and curing of the composition according to the present invention does not require any particular or special procedure, a conventional application method can be used. The wires typically have a diameter from 0.005 to 6 mm. Suitable wires include conventional metal ones, preferably copper, aluminium or alloys thereof. There are no restrictions with regard to wire shape, in particular either round or rectangular wires can be used. The composition of the present invention can be applied as single coat, double coat or multi-layer coat.
The composition may be applied in conventional layer thickness, dry layer thickness being in accordance with the standardised values for thin and thick wires. The composition of the present invention is applied on the wire and cured in a horizontal or vertical oven. The wire can be coated and cured from one to several times in succession. As curing temperature, a suitable range can vary from 300 to 800° C., according to the conventional parameters used for enamels and the nature of the wire to be coated. Enamelling conditions, such as number of passes, enamelling speed, oven temperature depend on the nature of the wire to be coated.

To enhance the cut through resistance of a wire coated with the composition of the current invention, nano particles may also be included in the composition according to the present invention.

The nanoparticles which can be used in the composition according to the invention are particles whose average radius is in the range from 1 to 300 nm, preferably in a range from 2 to 100 nm, particularly preferably in a range from 5 to 65 nm. Examples of preferred nanoparticles are nano-oxides, nano-metaloxides, colloidal oxides, colloidal metaloxides, metaloxides or hydrated oxides of aluminium, tin, boron, germanium, gallium, lead, transition metals and lanthanides and actinides, particularly of the series comprising aluminium, silicon, titanium, zinc, yttrium, vanadium, zirconium and/or nickel, preferably aluminium, silicon, titanium and/or zirconium, which are nanosized in the dispersed phase, which can be employed alone or in combination. Among nanometaloxides, nanoaluminas are the most preferred. Examples of nanoaluminas are: BYK-LP X 20693 and NanoBYK 3610 by BYK-Chemie GmbH Nycol Al20OSD by Nycol Nano Technologies Inc., Dispal X-25 SR and SRL, Disperal P2, P3, OS1 and OS2 by Sasol Germany GmbH. Among nanoaluminas, ceramic particles of aluminium oxide pre-dispersed in a polar solvent, such as BYK-LP X 20693 and NanoBYK 3610 by BYK-Chemie GmbH are preferred. The nanoparticles can be used together with coupling agents. As coupling agents, any commonly known functional alkoxy- or aryloxy-silanes may be used. Among functional silanes, (isocyanatoalkyl)-trialkoxy silanes, (aminoalkyl)-trialkoxy silanes, (trialkoxysilyl)-alkyl anhydrides, oligomeric diamino-silane-systems are preferred. The alkyl radical and the alkoxy group of the functional silane having 1 to 6 carbon atoms and more preferably 1 to 4. The aforementioned alkyl and alkoxy groups may further have a substituent thereon. Also useful as coupling agents are titanates and/or zirconates. Any common ortho-titanic or zirconic acid ester may be used such as, for example, tetraisopropyl, tetrabutyl, acetylacetone, acetonacetic acid esters, diethanolamine, triethanolamine, cresyl titanate or zirconate.
To enhance the dispersion of nanoparticles in the polymer solution matrix, coupling agents such as functional silanes, titanates or zirconates may be added directly to the nanoparticle dispersion and herein mixed before it is loaded to the polymer resin solution or may be added directly to the polymer solution before adding the nanoparticles dispersion. Coupling agents may alternatively be mixed to the polymer solution prior to the nanoparticle dispersion loading, for a better linkage of the inorganic moiety to the organic one. The mixture of polymer solution and coupling agent may be stirred at room temperature or at temperatures relatively low for a few hours, before nanometal oxide solution is added.

The enamelled wires made were tested in accordance to IEC 60851.

Measurement Methods

Mw is measured in accordance with DIN 55672-2;

Mn is measured in accordance with DIN 55672-2;

Viscosity is measured in accordance with ASTM D 3288;

Mandrel test is measured in accordance with IEC 60851—Part 3

Ethanol resistance is measured in accordance with IEC 60851—Part 4

Cut through test is measured in accordance with IEC 60851—Part 6

Tanδ is measured in accordance with IEC 60851—Part 5

Jerk test is measured in accordance with IEC 60851—Part 3

### Examples

Example 1 (comparative): Experiment 1 from WO2013/107822 was repeated under exactly the same conditions to prepare a polyamideimide solution in N-n-bytyl pyrrolidone (NBP). A polyamideimide solution was obtained with an average molecular weight of 7136 g/mole (Sample 1)

Example 2: 18.08 parts by weight (pbw) of trimellitic anhydride, 23.5 pbw of 4,4′- diphenylmethane diisocyanate, 0.12 pbw of formic acid and 58.29 pbw of NBP were charged in a reaction vessel and heated up to 85° C. The mixture was held for 2 hours at 85° C., then slowly heated up to 100° C. The temperature in the reaction vessel was kept at this temperature for several hours.

One hour after reaching 100° C. a sample was taken from the reaction vessel of 10.9 pbw and the molecular weight was measured at 9665 g/mole (Sample 2).

The reaction continued and after another hour a further sample of 10.9 pbw was taken from the reaction vessel and the molecular weight was measured at 15593 g/mole (Sample 3).

The reaction continued and after another hour a further sample of 10.9 pbw was taken from the reaction vessel and the molecular weight was measured at 16771 g/mole (Sample 4).

The reaction continued and after a total reaction time of 7 hours at 100° C. a further sample of 10.9 pbw was taken from the reaction vessel and the molecular weight was measured at 24583 g/mole. This sample was further diluted with benzyl alcohol to reach a viscosity of 13000 mPas at 23° C. (Sample 5).

Example 3: All samples that were collected in Examples 1 and 2 were subjected to typical wire enamel testing. In this comparison, also a commercially available polyamideimide resin solution in NMP (Sample 6) was used. The results of these test are presented in Table 1

TABLE 1
Testing results

| Parameter | R | 1* | 2* | 3 | 4 | 5 | 6* |
|---|---|---|---|---|---|---|---|
| Mw (g/mol) | | 7136 | 9665 | 15593 | 16771 | 24583 | — |
| Mn (g/mol) | | | | 9940 | 10572 | 13917 | |
| Mw/Mn | | | | 1.57 | 1.59 | 1.77 | |
| Solid content (%) | | | | 40.3 | 39.9 | 39.5 | |
| Viscosity at 23º mPas | | | | 592 | 905 | 2440 | |
| Application speed | ≥42 | <42 | 42 | 42 | 42 | 42 | 42 |
| (m/min) | | | | | | | |
| Mandrel test | 3/3 | | 2/3 | 3/3 | | 3/3 | 3/3 |
| 0% pre-stretching | | | | | | | |
| Mandrel test | 3/3 | | 1/3 | 3/3 | | 3/3 | 3/3 |
| 5% pre-stretching | | | | | | | |
| Mandrel test | 3/3 | | 0/3 | 3/3 | | 3/3 | 3/3 |
| 10% pre-stretching | | | | | | | |
| Mandrel test | ≥2/3 | | | 3/3 | | 3/3 | 3/3 |
| 15% pre-stretching | | | | | | | |
| Jerk test | Pass | Fail | Pass | Pass | Pass | Pass | Pass |
| Tanδ | 265- | | 259 | 267 | | 265 | 275 |
| | 285 | | | | | | |
| Ethanol resistance | Pass | Fail | Fail | Pass | Pass | Pass | Pass |
| Cut Trough value | ≥380 | | 360 | 380 | | 380 | 390 |

R: Requirement for commercial use
*) Comparative example

1. A composition comprising
a. from 55 to 65 parts by weight of N-n-butyl pyrrolidone,
b. from 25 to 40 parts by weight of polyamideimide resin,
c. from 0 to 20 parts by weight of other components,
wherein the polyamideimide resin has a Mw of between 10000 to 40000 g/mol (Dalton) and a Mw/Mn ratio between 1.1 and 2.

2. The composition of claim 1 further comprising nanoparticles having an average diameter in the range from 1 to 300 nm.

3. (canceled)

4. A process for the preparation of a polyamideimide resin comprising:
providing a mixture comprising tricarboxylic acid, or an anhydride thereof, having 2 carboxyl groups in a vicinal position, a diisocyanate, a moderator compound, and N-n-butyl pyrrolidone;
reacting said mixture at a temperature in the range from 80-120° C. until a polyamideimide resin is obtained having a Mw in the range from 10000 to 40000 g/mol (Dalton) and a Mw/Mn ratio between 1.1 and 2.

5. The process according to claim 4, wherein the moderator compound is a low molecular weight monocarboxylic acid.

6. The process according to claim 5, wherein the low molecular weight monocarboxylic acid comprises one or more of formic acid, acetic acid and propionic acid.

7. The process according to claim 4, wherein the mixture also comprises nanoparticles having an average diameter in the range from 1 to 300 nm.

8. A process for coating a metal wire wherein the wire is coated with the composition of claim 1.

9. A composition obtained by reacting a mixture comprising tricarboxylic acid, or an anhydride thereof, having 2 carboxyl groups in a vicinal position, a diisocyanate, a moderator compound, and N-n-butyl pyrrolidone at a temperature in the range from 80-120° C.

10. The process according to claim 9, wherein the moderator compound is a low molecular weight monocarboxylic acid.

11. The process according to claim 10, wherein the low molecular weight monocarboxylic acid comprises one or more of formic acid, acetic acid and propionic acid.

12. The process according to claim 11, wherein the mixture also comprises nanoparticles having an average diameter in the range from 1 to 300 nm.
